(19) United States
(12) Patent Application Publication
(10) Pub. No.: US 2017/0311230 A1
(43) Pub. Date: Oct. 26, 2017

(54) METHOD OF MEASURING SMALL CELL BASED ON DISCOVERY SIGNAL, AND USER EQUIPMENT

(71) Applicant: LG ELECTRONICS INC., Seoul (KR)

(72) Inventors: Yoonoh YANG, Seoul (KR); Sangwook LEE, Seoul (KR); Suhwan LIM, Seoul (KR); Manyoung JUNG, Seoul (KR); Jinyup HWANG, Seoul (KR)

(73) Assignee: LG ELECTRONICS INC., Seoul (KR)

(21) Appl. No.: 15/509,843

(22) PCT Filed: Sep. 23, 2015
(86) PCT No.: PCT/KR2015/010005

§ 371 Date: Mar. 8, 2017

Related U.S. Application Data
(60) Provisional application No. 62/056,621, filed on Sep. 29, 2014.
(60) Provisional application No. 62/056,620, filed on Sep. 29, 2014.

(51) Int. Cl. H04W 48/08; H04W 72/04; H04W 48/16; H04L 5/00; H04W 56/00; H04J 11/00

(52) U.S. Cl. CPC H04W 48/08; H04W 72/048; H04W 72/0453; H04W 72/0446; H04W 56/001; H04W 48/16; H04L 5/0032; H04J 11/0079; H04J 11/0076; H04J 11/0073

(57) ABSTRACT

The present disclosure provides a method of measuring a small cell based on a discovery signal. The method may include the step of receiving a discovery signal measurement timing configuration (DMTC) for a neighboring small cell. In this step, the DMTC may include DMTC periodicity information and information on a discovery signal occasion section. The information on the discovery signal occasion section may indicate one or more sub-frames in which the discovery signal occurs. The method may include the step of measuring the neighboring small cell for a measurement gap in the case where the neighboring small cell operates at a frequency that is different from a serving cell.

### BACKGROUND OF THE INVENTION

### Field of the Invention

The present invention relates to mobile communication.

### Related Art

3rd generation partnership project (3GPP) long term evolution (LTE) evolved from a universal mobile telecommunications system (UMTS) is introduced as the 3GPP release 8. The 3GPP LTE uses orthogonal frequency division multiple access (OFDMA) in a downlink, and uses single carrier-frequency division multiple access (SC-FDMA) in an uplink. The 3GPP LTE employs multiple input multiple output (MIMO) having up to four antennas. In recent years, there is an ongoing discussion on 3GPP LTE-advanced (LTE-A) evolved from the 3GPP LTE.

As disclosed in 3GPP TS 36.211 V10.4.0 (2011-12) “Evolved Universal Terrestrial Radio Access (E-UTRA); Physical Channels and Modulation (Release 10)”, a physical channel of LTE may be classified into a downlink channel, i.e., a PDSCH (Physical Downlink Shared Channel) and a PDCCH (Physical Downlink Control Channel), and an uplink channel, i.e., a PUSCH (Physical Uplink Shared Channel) and a PUCCH (Physical Uplink Control Channel).

Meanwhile, in a next-generation mobile communication system, it is expected that a small cell having a small cell coverage radius is added within a coverage of a macro cell.

However, if the small cell is densely deployed within the coverage of the macro cell, it may be difficult for a UE (User Equipment) to detect the small cell.

In order to solve the above mentioned problem, the small cell may a new DS (Discovery Signal) in addition to an existing PSS (Primary Synchronization Signal)/SSS (Secondary Synchronization Signal).

Meanwhile, if the small cell is operated on a frequency different from a frequency of a serving cell, the UE should retune a RF (Radio frequency) to measure the small cell. While the UE retunes the RF frequency, there is an issue that the UE may not receive the discovery signal.

### SUMMARY OF THE INVENTION

Accordingly, an object of the present invention is to solve the above-mentioned problems.

To achieve the foregoing aspect, there is provided a method for measuring a discovery signal of a small cell. The method may comprise: receiving a discovery signal measurement timing configuration (DMTC) for a neighboring small cell. The DMTC may include information on a DMTC periodicity and information on an occasion duration of the discovery signal. The occasion duration of the discovery signal may indicate at least one subframe on which the discovery signal occurs. The method may comprise: if the neighboring small cell operates in a frequency different from a frequency of a serving cell, performing a measurement on the neighboring small cell during a measurement gap. The at least one subframe on which the discovery signal occurs and indicated by the information on the occasion duration may be distanced by a predetermined offset from the measurement gap. The predetermined offset may include at least one slot or more than one slot.

The information on a DMTC periodicity may indicate one of 40 ms, 80 ms, and 160 ms.

The at least one subframe on which the discovery signal occurs and indicated by the information on the occasion duration may include a number of one through five subframes.

The DMTC and the measurement gap may be received as being included in measurement configuration information.

The discovery signal may includes one or more of a primary synchronization signal (PSS), a secondary synchronization signal (SSS), a cell-specific reference Signal (CRS) and a channel state information reference signal (CSI-RS).

If the serving cell and the neighboring small cell are synchronized in time, the offset for the CRS, the PSS and the SSS of the discovery signal is a length of at least one subframe.

If a value of the offset is 0, a CSI-RS configuration is used of which a time duration required retuning a RF to the different frequency for measuring the neighboring small cell, is not overlapped.

To achieve the foregoing aspect, there is also provided a user equipment for measuring a discovery signal of a small cell. The user equipment may comprise: a radio frequency (RF) unit configured to receive a discovery signal measurement timing configuration (DMTC) for a neighboring small cell. The DMTC may include information on a DMTC periodicity and information on an occasion duration of the discovery signal. The occasion duration of the discovery signal may indicate at least one subframe on which the discovery signal occurs. The user equipment may comprise a processor configured to perform a measurement on the neighboring small cell during a measurement gap, if the neighboring small cell operates in a frequency different from a frequency of a serving cell. The at least one subframe on which the discovery signal occurs and indicated by the information on the occasion duration may be distanced by a predetermined offset from the measurement gap. The predetermined offset may include at least one slot or more than one slot.

Meanwhile, to achieve the foregoing aspect, there is also provided a method for measuring a discovery signal of a small cell. The method may comprise: receiving measurement configuration information from a serving cell. The measurement configuration information may comprise a measurement gap indicating a time duration for measuring a neighboring small cell operated in a frequency different from a frequency of the serving cell, and a discovery signal measurement timing configuration (DMTC) for the neighboring small cell. Further, the DMTC may include information on an occasion duration of the discovery signal and offset information. The method may comprise: performing a measurement based on the discovery signal received from the small cell during the occasion duration of the discovery signal from a position distanced by the offset.

In accordance with the disclosure of the present specification, the above mentioned problem will be solved.

### BRIEF DESCRIPTION OF THE DRAWINGS

FIG. 1 is a wireless communication system.

FIG. 2 illustrates a structure of a radio frame according to FDD in 3GPP LTE.

FIG. 3 illustrates a structure of a downlink radio frame according to TDD in the 3GPP LTE.

FIG. 4 is an exemplary diagram illustrating a resource grid for one uplink or downlink slot in the 3GPP LTE.

FIG. 5 illustrates a structure of a downlink subframe.

FIG. 6 illustrates the architecture of an uplink sub-frame in 3GPP LTE.

FIG. 7 illustrates a frame structure for transmitting a synchronization signal in a FDD frame.

FIG. 8 illustrates a frame structure for transmitting a synchronization signal in a TDD frame.

FIG. 9 illustrates an exemplary pattern with which a CRS is mapped to a RB, if a base station uses a single antenna port.

FIG. 10 illustrates a measurement and a measurement report procedure.

FIG. 11 illustrates an exemplary RB to which a CSI-RS of reference signals is mapped.

FIG. 12 is a diagram illustrating a heterogeneous network environment in which a macro cell and small cells having a possibility that they may become the next-generation wireless communication system are mixed.

FIG. 13 is an exemplary diagram illustrating the situation in which small cells have been densely deployed.

FIG. 14 illustrates an example in which the small cell transmits a discovery signal.

FIG. 15 illustrates an example of the discovery signal.

FIG. 16 illustrates an example in which the macro cell and the small cell are operated on different frequencies.

FIG. 17a and FIG. 17b illustrates an example occurred when a measurement gap (MG) and a DMTC occasion duration for measuring on different frequencies is identical to each other.

FIG. 18 illustrates an example in which a subframe in which the discovery signal (DS) is started to be occurred is offset from the measurement gap (MG) in accordance with an example of the present specification.

FIG. 19 is a flow diagram illustrating and arranging the disclosure of the present specification.

FIG. 20 is a block diagram illustrating a wireless communications system in which the disclosure of the present specification is implemented.

### DESCRIPTION OF EXEMPLARY EMBODIMENTS

Hereinafter, based on 3rd Generation Partnership Project (3GPP) long term evolution (LTE) or 3GPP LTE-advanced (LTE-A), the present invention will be applied. This is just an example, and the present invention may be applied to various wireless communication systems. Hereinafter, LTE includes LTE and/or LTE-A.

The technical terms used herein are used to merely describe specific embodiments and should not be construed as limiting the present invention. Further, the technical terms used herein should be, unless defined otherwise, interpreted as having meanings generally understood by those skilled in the art but not too broadly or too narrowly. Further, the technical terms used herein, which are determined not to exactly represent the spirit of the invention, should be replaced by or understood by such technical terms as being able to be exactly understood by those skilled in the art. Further, the general terms used herein should be interpreted in the context as defined in the dictionary, but not in an excessively narrowed manner.

The expression of the singular number in the present invention includes the meaning of the plural number unless the meaning of the singular number is definitely different from that of the plural number in the context. In the following description, the term ‘include’ or ‘have’ may represent the existence of a feature, a number, a step, an operation, a component, a part or the combination thereof described in the present invention, and may not exclude the existence or addition of another feature, another number, another step, another operation, another component, another part or the combination thereof.

The terms ‘first’ and ‘second’ are used for the purpose of explanation about various components, and the components are not limited to the terms ‘first’ and ‘second’. The terms ‘first’ and ‘second’ are only used to distinguish one component from another component. For example, a first component may be named as a second component without deviating from the scope of the present invention.

It will be understood that when an element or layer is referred to as being “connected to” or “coupled to” another element or layer, it can be directly connected or coupled to the other element or layer or intervening elements or layers may be present. In contrast, when an element is referred to as being “directly connected to” or “directly coupled to” another element or layer, there are no intervening elements or layers present.

Hereinafter, exemplary embodiments of the present invention will be described in greater detail with reference to the accompanying drawings. In describing the present invention, for ease of understanding, the same reference numerals are used to denote the same components throughout the drawings, and repetitive description on the same components will be omitted. Detailed description on well-known arts which are determined to make the gist of the invention unclear will be omitted. The accompanying drawings are provided to merely make the spirit of the invention readily understood, but not should be intended to be limiting of the invention. It should be understood that the spirit of the invention may be expanded to its modifications, replacements or equivalents in addition to what is shown in the drawings.

As used herein, ‘base station’ generally refers to a fixed station that communicates with a wireless device and may be denoted by other terms such as eNB (evolved-NodeB), BTS (base transceiver system), or access point.

As used herein, ‘user equipment (UE)’ may be stationary or mobile, and may be denoted by other terms such as device, wireless device, terminal, MS (mobile station), UT (user terminal), SS (subscriber station), MT (mobile terminal) and etc.

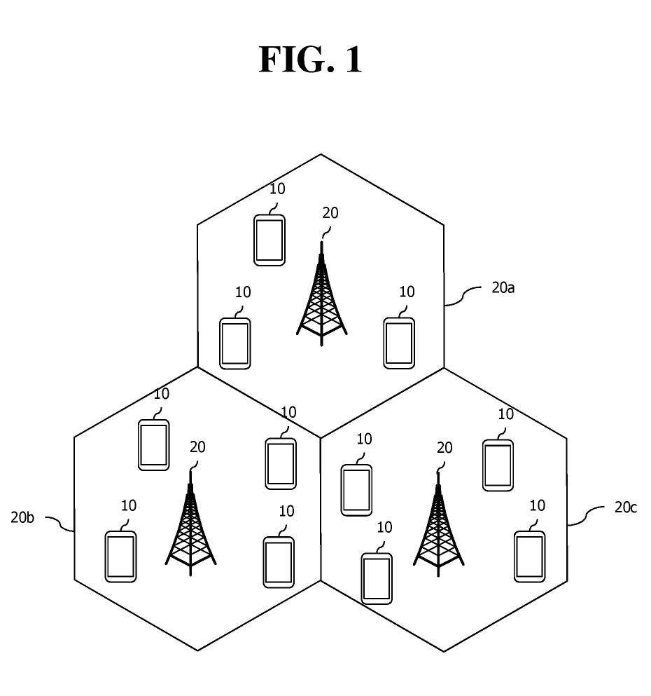

FIG. 1 illustrates a wireless communication system.

As seen with reference to FIG. 1, the wireless communication system includes at least one base station (BS) 20. Each base station 20 provides a communication service to specific geographical areas (generally, referred to as cells) 20a, 20b, and 20c. The cell can be further divided into a plurality of areas (sectors).

The UE generally belongs to one cell and the cell to which the UE belong is referred to as a serving cell. A base station that provides the communication service to the serving cell is referred to as a serving BS. Since the wireless communication system is a cellular system, another cell that neighbors to the serving cell is present. Another cell which neighbors to the serving cell is referred to a neighbor cell. A base station that provides the communication service to the neighbor cell is referred to as a neighbor BS. The serving cell and the neighbor cell are relatively decided based on the UE.

Hereinafter, a downlink means communication from the base station 20 to the UE1 10 and an uplink means communication from the UE 10 to the base station 20. In the downlink, a transmitter may be a part of the base station 20 and a receiver may be a part of the UE 10. In the uplink, the transmitter may be a part of the UE 10 and the receiver may be a part of the base station 20.

Meanwhile, the wireless communication system may be generally divided into a frequency division duplex (FDD) type and a time division duplex (TDD) type. According to the FDD type, uplink transmission and downlink transmission are achieved while occupying different frequency bands. According to the TDD type, the uplink transmission and the downlink transmission are achieved at different time while occupying the same frequency band. A channel response of the TDD type is substantially reciprocal. This means that a downlink channel response and an uplink channel response are approximately the same as each other in a given frequency area. Accordingly, in the TDD based wireless communication system, the downlink channel response may be acquired from the uplink channel response. In the TDD type, since an entire frequency band is time-divided in the uplink transmission and the downlink transmission, the downlink transmission by the base station and the uplink transmission by the terminal may not be performed simultaneously. In the TDD system in which the uplink transmission and the downlink transmission are divided by the unit of a sub-frame, the uplink transmission and the downlink transmission are performed in different sub-frames.

Hereinafter, the LTE system will be described in detail.

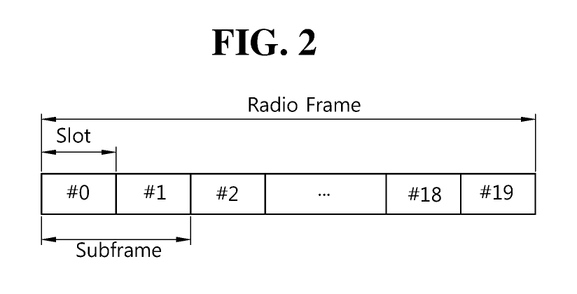

FIG. 2 shows a downlink radio frame structure according to FDD of 3rd generation partnership project (3GPP) long term evolution (LTE).

The radio frame of FIG. 2 may be found in the section 5 of 3GPP TS 36.211 V10.4.0 (2011-12) “Evolved Universal Terrestrial Radio Access (E-UTRA); Physical Channels and Modulation (Release 10)”.

The radio frame includes 10 sub-frames indexed 0 to 9. One sub-frame includes two consecutive slots. Accordingly, the radio frame includes 20 slots. The time taken for one sub-frame to be transmitted is denoted TTI (transmission time interval). For example, the length of one sub-frame may be 1 ms, and the length of one slot may be 0.5 ms.

The structure of the radio frame is for exemplary purposes only, and thus the number of sub-frames included in the radio frame or the number of slots included in the sub-frame may change variously.

Meanwhile, one slot may include a plurality of orthogonal frequency division multiplexing (OFDM) symbols. The number of OFDM symbols included in one slot may vary depending on a cyclic prefix (CP). One slot includes 7 OFDM symbols in case of a normal CP, and one slot includes 6 OFDM symbols in case of an extended CP. Herein, since the 3GPP LTE uses orthogonal frequency division multiple access (OFDMA) in a downlink (DL), the OFDM symbol is only for expressing one symbol period in a time domain, and there is no limitation in a multiple access scheme or terminologies. For example, the OFDM symbol may also be referred to as another terminology such as a single carrier frequency division multiple access (SC-FDMA) symbol, a symbol period, etc.

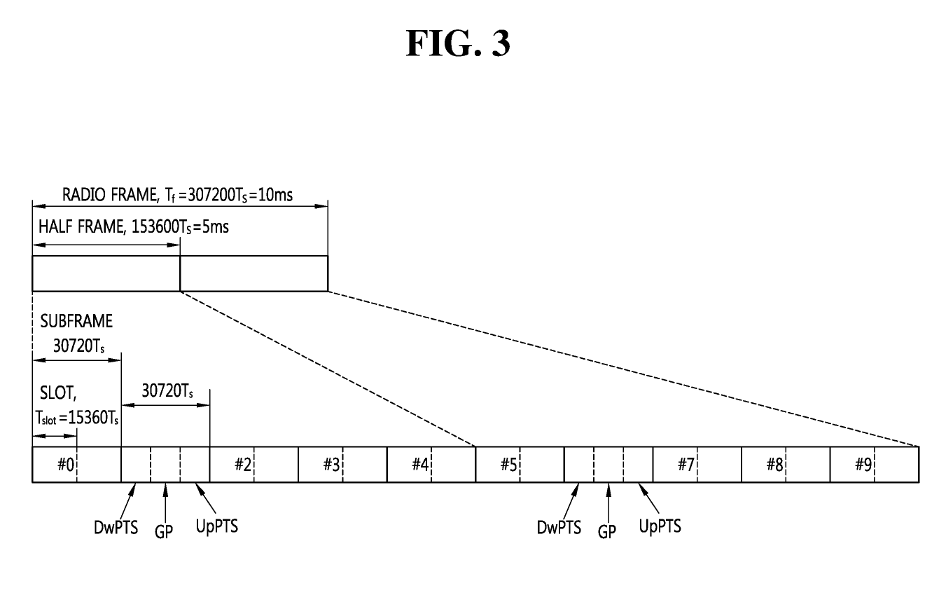

FIG. 3 illustrates the architecture of a downlink radio frame according to TDD in 3GPP LTE.

For this, 3GPP TS 36.211 V10.4.0 (2011-12) “Evolved Universal Terrestrial Radio Access (E-UTRA); Physical Channels and Modulation (Release 8)”, Ch. 4 may be referenced, and this is for TDD (time division duplex).

Sub-frames having index #1 and index #6 are denoted special sub-frames, and include a DwPTS (Downlink Pilot Time Slot: DwPTS), a GP (Guard Period) and an UpPTS (Uplink Pilot Time Slot). The DwPTS is used for initial cell search, synchronization, or channel estimation in a terminal. The UpPTS is used for channel estimation in the base station and for establishing uplink transmission sync of the terminal. The GP is a period for removing interference that arises on uplink due to a multi-path delay of a downlink signal between uplink and downlink.

In TDD, a DL (downlink) sub-frame and a UL (Uplink) co-exist in one radio frame. Table 1 shows an example of configuration of a radio frame.

TABLE 1

| | Switch- | | | | | | | | | | |
|---|---|---|---|---|---|---|---|---|---|---|---|
| UL-DL | point | | | | | | | | | | |
| configu- | period- | Subframe index | | | | | | | | | |
| ration | icity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

‘D’ denotes a DL sub-frame, ‘U’ a UL sub-frame, and ‘S’ a special sub-frame.

When receiving a UL-DL configuration from the base station, the terminal may be aware of whether a sub-frame is a DL sub-frame or a UL sub-frame according to the configuration of the radio frame.

TABLE 2

| | Normal CP in downlink | | | Extended CP in downlink | | |
|---|---|---|---|---|---|---|
| | | UpPTS | | | UpPTS | |
| Special | | Normal | Extended | | Normal | Extended |
| subframe | | CP in | CP in | | CP in | CP in |
| configuration | DwPTS | uplink | uplink | DwPTS | uplink | uplink |
| 0 | 6592*Ts | 2192*Ts | 2560*Ts | 7680*Ts | 2192*Ts | 2560*Ts |
| 1 | 19760*Ts | | | 20480*Ts | | |
| 2 | 21952*Ts | | | 23040*Ts | | |
| 3 | 24144*Ts | | | 25600*Ts | | |
| 4 | 26336*Ts | | | 7680*Ts | 4384*Ts | 5120*ts |
| 5 | 6592*Ts | 4384*Ts | 5120*ts | 20480*Ts | | |
| 6 | 19760*Ts | | | 23040*Ts | | |
| 7 | 21952*Ts | | | — | | |
| 8 | 24144*Ts | | | — | | |

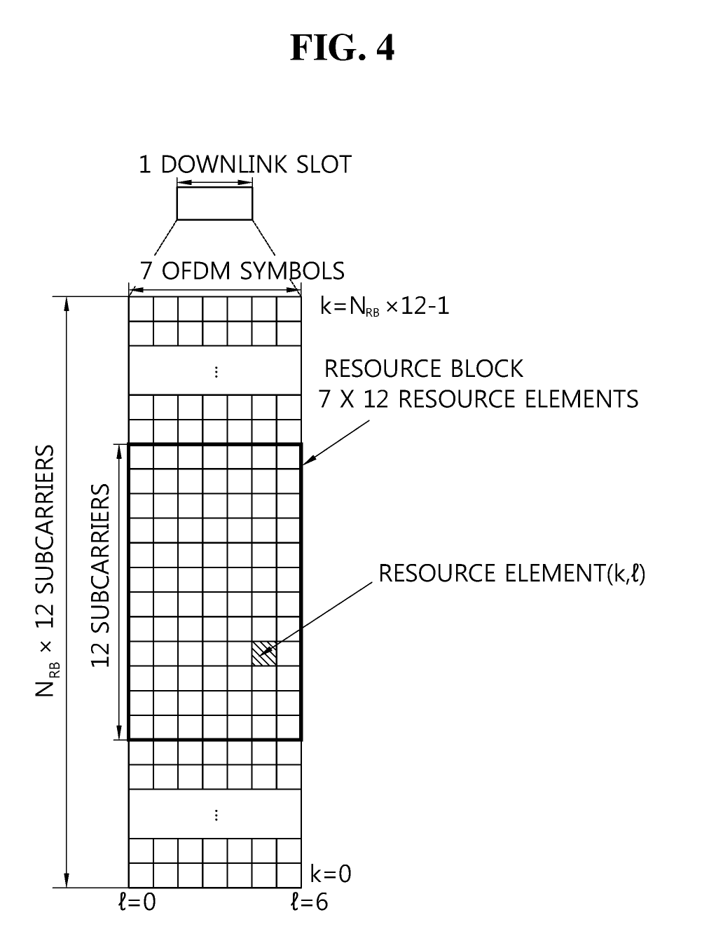

FIG. 4 Illustrates an Example Resource Grid for One Uplink or Downlink Slot in 3GPP LTE.

Referring to FIG. 4, the uplink slot includes a plurality of OFDM (orthogonal frequency division multiplexing) symbols in the time domain and NRB resource blocks (RBs) in the frequency domain. For example, in the LTE system, the number of resource blocks (RBs), i.e., NRB, may be one from 6 to 110.

The resource block is a unit of resource allocation and includes a plurality of sub-carriers in the frequency domain. For example, if one slot includes seven OFDM symbols in the time domain and the resource block includes 12 sub-carriers in the frequency domain, one resource block may include 7×12 resource elements (REs).

Meanwhile, the number of sub-carriers in one OFDM symbol may be one of 128, 256, 512, 1024, 1536, and 2048.

In 3GPP LTE, the resource grid for one uplink slot shown in FIG. 4 may also apply to the resource grid for the downlink slot.

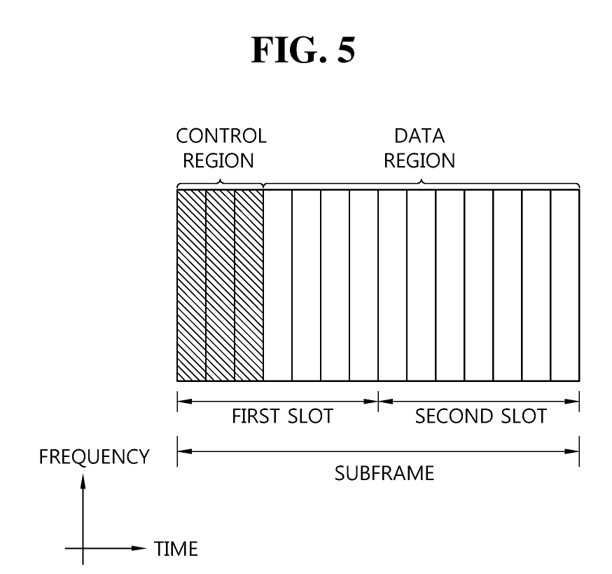

FIG. 5 Illustrates the Architecture of a Downlink Sub-Frame.

In FIG. 5, assuming the normal CP, one slot includes seven OFDM symbols, by way of example.

The DL (downlink) sub-frame is split into a control region and a data region in the time domain. The control region includes up to first three OFDM symbols in the first slot of the sub-frame. However, the number of OFDM symbols included in the control region may be changed. A PDCCH (physical downlink control channel) and other control channels are assigned to the control region, and a PDSCH is assigned to the data region.

The physical channels in 3GPP LTE may be classified into data channels such as PDSCH (physical downlink shared channel) and PUSCH (physical uplink shared channel) and control channels such as PDCCH (physical downlink control channel), PCFICH (physical control format indicator channel), PHICH (physical hybrid-ARQ indicator channel) and PUCCH (physical uplink control channel).

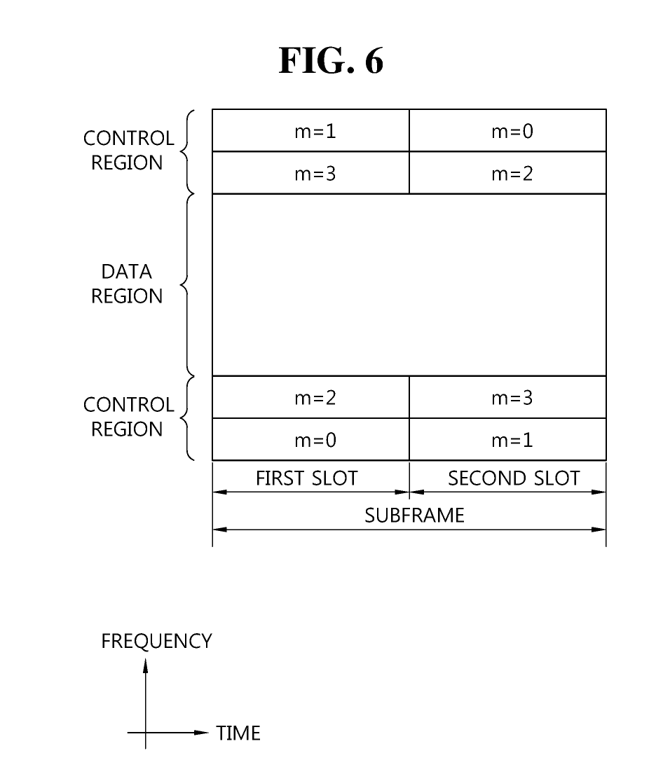

FIG. 6 Illustrates the Architecture of an Uplink Sub-Frame in 3GPP LTE.

Referring to FIG. 6, the uplink sub-frame may be separated into a control region and a data region in the frequency domain. The control region is assigned a PUCCH (physical uplink control channel) for transmission of uplink control information. The data region is assigned a PUSCH (physical uplink shared channel) for transmission of data (in some cases, control information may also be transmitted).

The PUCCH for one terminal is assigned in resource block (RB) pair in the sub-frame. The resource blocks in the resource block pair take up different sub-carriers in each of the first and second slots. The frequency occupied by the resource blocks in the resource block pair assigned to the PUCCH is varied with respect to a slot boundary. This is referred to as the RB pair assigned to the PUCCH having been frequency-hopped at the slot boundary.

The terminal may obtain a frequency diversity gain by transmitting uplink control information through different sub-carriers over time. m is a location index that indicates a logical frequency domain location of a resource block pair assigned to the PUCCH in the sub-frame.

The uplink control information transmitted on the PUCCH includes an HARQ (hybrid automatic repeat request), an ACK (acknowledgement)/NACK (non-acknowledgement), a CQI (channel quality indicator) indicating a downlink channel state, and an SR (scheduling request) that is an uplink radio resource allocation request.

The PUSCH is mapped with a UL-SCH that is a transport channel. The uplink data transmitted on the PUSCH may be a transport block that is a data block for the UL-SCH transmitted for the TTI. The transport block may be user information. Or, the uplink data may be multiplexed data. The multiplexed data may be data obtained by multiplexing the transport block for the UL-SCH and control information. For example, the control information multiplexed with the data may include a CQI, a PMI (precoding matrix indicator), an HARQ, and an RI (rank indicator). Or, the uplink data may consist only of control information.

<Carrier Aggregation (CA>

A carrier aggregation system is described hereinafter.

A carrier aggregation system aggregates a plurality of component carriers (CCs). A conventional definition of a cell is changed according to carrier aggregation. According to carrier aggregation, a cell may denote a combination of a downlink component carrier and an uplink component carrier or a downlink component carrier alone.

Further, in carrier aggregation, cells may be divided into a primary cell, a secondary cell, and a serving cell. A primary cell denotes a cell operating at a primary frequency, in which a UE performs an initial connection establishment procedure or a connection reestablishment procedure with a BS or which is designated as a primary cell in a handover procedure. A secondary cell denotes a cell operating at a secondary frequency, which is configured once RRC connection is established and is used to provide an additional radio resource.

As described above, the carrier aggregation system may support a plurality of component carriers (CCs), that is, a plurality of serving cells, unlike a single carrier system.

The carrier aggregation system may support cross-carrier scheduling. Cross-carrier scheduling is a scheduling method for performing resource allocation for a PDSCH transmitted through a different component carrier through a PDCCH transmitted through a specific component carrier and/or resource allocation for a PUSCH transmitted through a component carrier different from a component carrier basically linked with the specific component carrier.

<Synchronization Signal>

In LTE/LTE-A systems, synchronization with a cell is obtained through a synchronization signal (SS) in a cell search process.

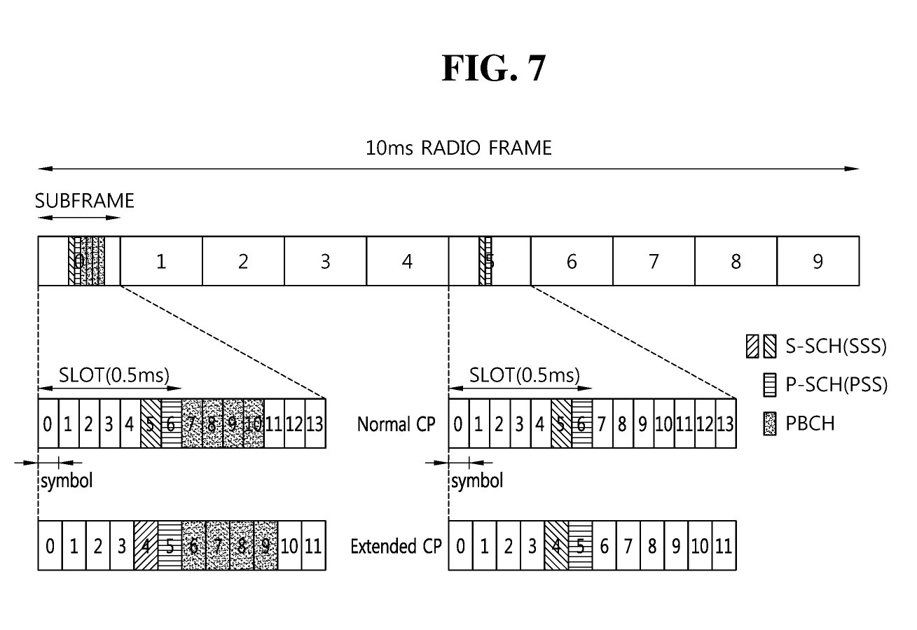

The synchronization signal is described in detail below with reference to FIG. 7.

FIG. 7 Illustrates a Frame Structure for the Transmission of a Synchronization Signal in an FDD Frame.

A slot number and a subframe number starts with 0. UE may perform time and frequency synchronization based on a synchronization signal received from an eNodeB. In 3GPP LTE-A, a synchronization signal is used for cell search and may be divided into a primary synchronization signal (PSS) and a secondary synchronization signal (SSS). In 3GPP LTE-A, for a synchronization signal, reference may be made to Paragraph 6.11 of 3GPP TS 36.211 V10.2.0 (2011-06).

A PSS is used to obtain OFDM symbol synchronization or slot synchronization and associated with a physical-layer cell identity (PCI). Furthermore, an SSS is used to obtain frame synchronization. Furthermore, an SSS is used to detect a CP length and to obtain a physical layer cell group ID.

A synchronization signal may be transmitted in a subframe No. 0 and a subframe No. 5 several time by taking into consideration 4.6 ms, that is, the length of a GSM (global system for mobile communication) frame in order to facilitate inter-RAT (radio access technology) measurement. The boundary of the frame may be detected through an SSS. More specifically, in an FDD system, a PSS is transmitted in the last OFDM symbol of a slot No. 1 or a slot No. 10, and an SSS is transmitted in an OFDM symbol right before a PSS.

A synchronization signal may send any one of a total of 504 physical cell IDs through a combination of three PSSs and 168 SSSs. A PBCH (physical broadcast channel) is transmitted in the first 4 OFDM symbols of the first slot. A synchronization signal and PBCH are transmitted within center 6 Rbs within a system bandwidth so that UE can detect or demodulate the synchronization signal regardless of a transmission bandwidth. A physical channel in which a PSS is transmitted is called a P-SCH, and a physical channel in which an SSS is transmitted is called an S-SCH.

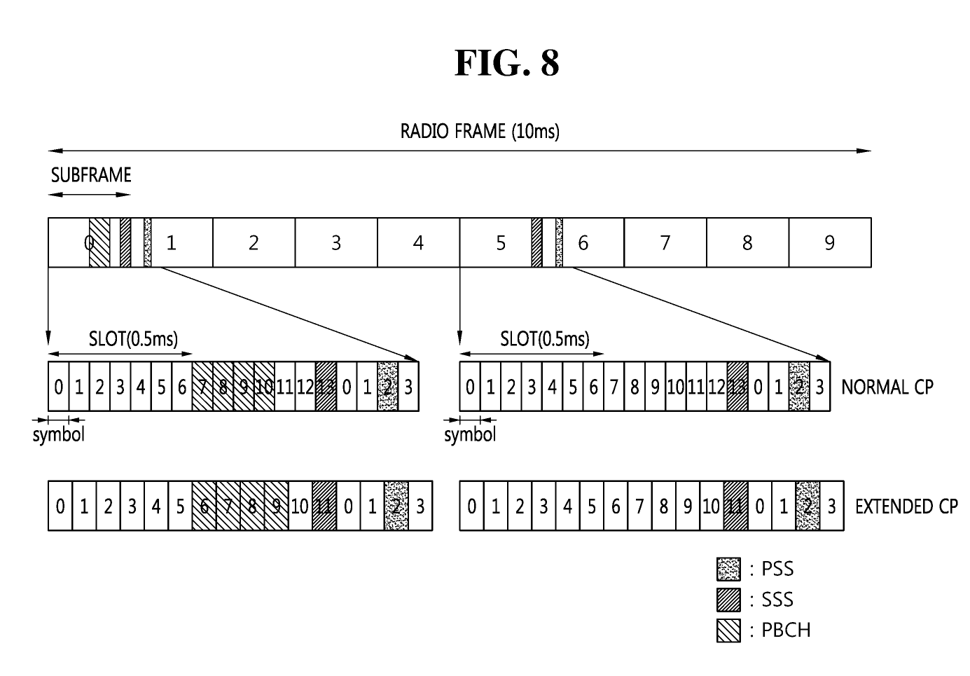

FIG. 8 Illustrates an Example of a Frame Structure for Sending a Synchronization Signal in a TDD Frame.

In a TDD frame, a PSS is transmitted in the third OFDM symbols of a third slot and thirteenth slot. An SSS is transmitted prior to three OFDM symbols in OFDM symbols in which a PSS is transmitted. A PBCH is transmitted in the first 4 OFDM symbols of a second slot in the first subframe.

<Reference Signal>

A RS is described below.

In general, transmission information, for example, data is easily distored and changed while it is transmitted through a radio channel. Accordingly, a reference signal is required in order to demodualte such a transmission information without an error.

The reference signal is a signal known to both a transmitter and a receiver and is transmitted along with transmission information. Since transmission information transmitted by a transmitter experiences a corresponding channel for each transmission antennaor layer, a reference signal may be allocated to each transmission antenna or layer. A reference signal for each transmission antenna or layer layer may be identified using resources, such as a frequency and code. A reference signal may be used for two purposes, that is, the demodulation and channel estimation of transmission information.

A downlink reference signal may be divided into a cell-specific reference signal (CRS), an MBSFN (multimedia broadcast and multicast single frequency network) reference signal, a UE-specific reference signal (UE-specific RS, URS), a positioning reference signal (positioning RS, PRS), and a CSI reference signal (CSI-RS). The CRS is a reference signal transmitted to all UEs within a cell and also called a common reference signal. The CRS may be used for the channel measurement of CQI feedback and the channel estimation of PDSCH. The MBSFN reference signal may be transmitted in a subframe allocated for MBSFN transmission. The URS is a reference signal received by a specific UE or specific UE group within a cell and may be called a demodulation reference signal (DM-RS). The DM-RS is chiefly used for a specific UE or specific UE group to perform data demodulation. The PRS may be used to estimate the location of UE. The CSI-RS is used for the channel estimation of the PDSCH of LTE-A UE. The CSI-RSs are deployed relatively sparsely in a frequency domain or time domain and may be punctured in the data region of a common subframe or MBSFN subframe.

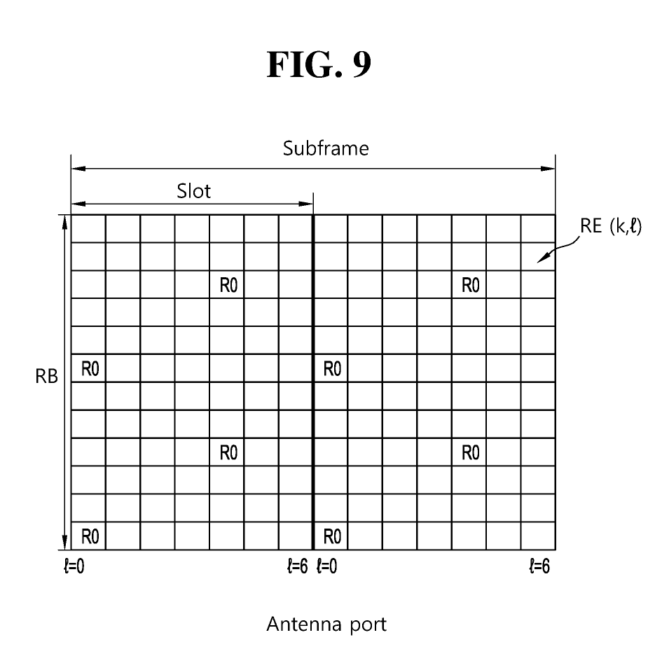

FIG. 9 Illustrates an Exemplary Pattern with which a CRS is Mapped to a RB, if a Base Station Uses a Single Antenna Port.

Referring to FIG. 9, R0 illustrates a resource element (RE) to which a CRS transmitted by antenna port number 0 of the base station is mapped.

The CRS is transmitted in all downlink subframes in a cell supporting a PDSCH transmission. The CRS may be transmitted on the antenna port number 0 to 3.

The RE allocated to the CRS of a single antenna port can not be used for the transmission of other antenna ports, and should be configured as zero. Further, the CRS is only transmitted on a non-MBSFN (multicast-broadcast single frequency network) region in a MBSFN subframe.

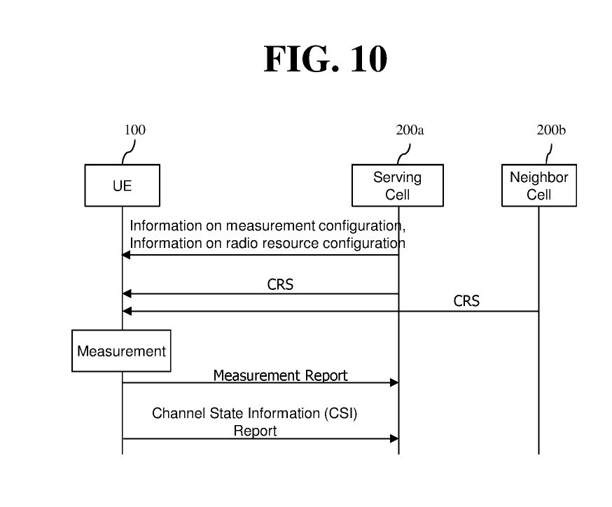

FIG. 10 Illustrates a Measurement and a Measurement Report Procedure.

In a mobile communication system, a mobility support for UE 100 is essential. Accordingly, the UE 100 continues to measure quality of a serving cell that now provides service to the UE 100 and quality of neighbor cells. The UE 100 reports a measurement result to a network at a proper time, and the network provides optimal mobility to the UE through handover. Measurement for such a purpose is frequently called radio resource management (RRM).

Meanwhile, the UE 100 monitors downlink quality of a primary cell (Pcell) based on a CRS. This is called RLM (Radio Link Monitoring). For such RLM, the UE 100 estimates downlink quality and compares the estimated downlink quality with thresholds, for example, Qout and Qin. The threshold Qout is defined as a level in which downlink reception cannot be stably performed, and corresponds to 10% error of PDCCH transmission by taking into consideration a PCFICH error. The threshold Qin is defined as a level in which downlink may be very significantly reliable compared to the threshold Qout, and corresponds to 2% error of PDCCH transmission by taking into consideration a PCFICH error.

As may be seen with reference to FIG. 10, when a serving cell 200a and a neighbor cell 200b transmits a respective CRS (Cell-specific Reference Signal) to the UE 100, the UE 100 performs measurement through the CRS and transmits an RRC measurement report message, including a measurement result, to the serving cell 200a.

In this case, the UE 100 may perform measurement using the following three methods.

1) RSRP (reference signal received power): This indicates the mean reception power of all REs that carry a CRS transmitted in the entire band. In this case, the mean reception power of all REs that carry a CSI RS instead of the CRS may be measured.

2) An RSSI (received signal strength indicator): This indicates reception power measured in the entire band. The RSSI includes all of a signal, interference, and thermal noise.

3) RSRQ (reference symbol received quality): This indicates a CQI, and may be determined to be an RSRP/RSSI according to a measurement bandwidth or subband. That is, the RSRQ means an SINR (signal-to-noise interference ratio). The RSRP does not provide sufficient mobility information, and thus RSRQ may be used in a handover or cell reselection process instead of RSRP.

The RSRQ may be calculated as an RSSI/RSSP.

Meanwhile, the UE 100 receives a measurement configuration (hereinafter also called “measconfing”) information element (IE) from the serving cell 100 a. A message including the measurement configuration IE is called a measurement configuration message. In this case, the measurement configuration IE may be received through an RRC connection reconfiguration message. If a measurement result satisfies a report condition within the measconfing information, the UE reports the measurement result to an eNodeB. A message including the measurement result is called as a measurement report message.

The measurement configuration IE may include measurement object information. The measurement object information is information about an object on which UE may perform measurement. The measurement object includes at least one of an intra-frequency measurement target that is the subject of intra-cell measurement, an inter-frequency measurement target that is the subject of inter-cell measurement, and an inter-RAT measurement target that is the subject of inter-RAT measurement. For example, the intra-frequency measurement target may indicate a neighbor cell having the same frequency band as a serving cell, and the inter-frequency measurement target may indicate a neighbor cell having a frequency band different from that of a serving cell, and the inter-RAT measurement target may indicate a neighbor cell having an RAT different from the RAT of a serving cell.

Specifically, the measurement configuration IE (Information Element) includes an IE, such as the following Table.

TABLE 3

MeasConfig ::=
-- Measurement objects

measObjectToRemoveList
measObjectToAddModList

-- Other parameters

measGapConfig

The Measurement objects IE includes measObjectToRemoveList indicative of a list of measObject to be removed and measObjectToAddModList indicative of a list that may be newly added or modified.

Meanwhile, the measGapConfig is used to configure or release the measurement gap (MG).

The measurement gap (MG) is a duration to perform a cell identification or a RSRP measurement on an inter frequency different from a frequency of the serving cell.

Meanwhile, the UE 100 receives a radio resource configuration (RRC) information element (IE) as shown.

The radio resource configuration (RRC) dedicated information element (IE) is used to configure/modify/release a radio bearer, or modify a MAC configuration etc. The radio resource configuration IE includes subframe pattern information. The subframe pattern information is information on a measurement resource restriction pattern in a time domain to measure the RSRP, and the RSRQ for the serving cell (e.g. a primary cell).

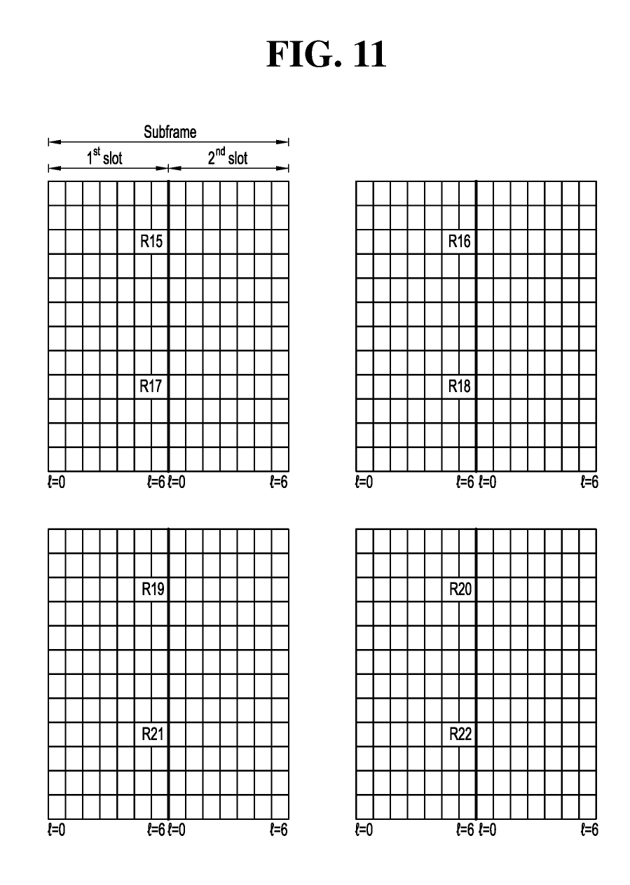

FIG. 11 illustrates an exemplary RB to which a CSI-RS of reference signals is mapped.

A CSI-RS is used for channel measurement for the channel estimation and channel information of the PDSCH of LTE-A UE. The CSI-RS is deployed relatively sparsely in a frequency domain or time domain and may be punctured in the data region of a subframe or MBSFN subframe. If it is required to estimate a CSI, a CQI, PMI, and RI may be reported by UE.

The CSI-RS is transmitted through a 1, 2, 4, or 8 antenna ports. Antenna ports used in this case are p=15, p=15, 16, p=15, . . . , 18, and p=15, . . . , 22. That is, the CSI-RS may be transmitted through 1, 2, 4, 8 antenna ports. The CSI-RS may be defined with respect to only a subcarrier duration Δf=15 kHz. For the CSI-RS, reference may be made to Paragraph 6.10.5 of 3GPP (3rd Generation Partnership Project) TS 36.211 V10.1.0 (March 2011) “Technical Specification Group Radio Access Network; Evolved Universal Terrestrial Radio Access (E-UTRA); Physical channels and modulation (Release 8).”

In the transmission of the CSI-RS, a maximum of 32 different configurations may be proposed in order to reduce ICI (inter-cell interference) in a multi-cell environment including a heterogeneous network (HetNet) environment. The CSI-RS configuration is different depending on the number of antenna ports within a cell and a CP, and a neighbor cell may have a different configuration to the greatest extent. Furthermore, the CSI-RS configuration may be divided into a case where it is applied to both an FDD frame and TDD frame and a case where it is applied to only a TDD frame depending on a frame structure. In a single cell, a plurality of CSI-RS configurations may be used. A zero or one CSI-RS configuration may be used for UE that assumes a non-zero power CSI-RS, and zero or some CSI-RS configurations may be used for UE that assumes a zero power CSI-RS.

The following table illustrates a configuration of the CSI-RS in a normal CP.

TABLE 4

| | CSI-RS | Number of CSI-RS configuration | | | | | |
|---|---|---|---|---|---|---|---|
| | configuration | 1 or 2 | | 4 | | 8 | |
| | index | (k′, l′) | nₛ mod 2 | (k′, l′) | nₛ mod 2 | (k′, l′) | nₛ mod 2 |
| TDD and | 0 | (9, 5) | 0 | (9, 5) | 0 | (9, 5) | 0 |
| FDD | 1 | (11, 2) | 1 | (11, 2) | 1 | (11, 2) | 1 |
| frame | 2 | (9, 2) | 1 | (9, 2) | 1 | (9, 2) | 1 |
| | 3 | (7, 2) | 1 | (7, 2) | 1 | (7, 2) | 1 |
| | 4 | (9, 5) | 1 | (9, 5) | 1 | (9, 5) | 1 |
| | 5 | (8, 5) | 0 | (8, 5) | 0 | | |
| | 6 | (10, 2) | 1 | (10, 2) | 1 | | |
| | 7 | (8, 2) | 1 | (8, 2) | 1 | | |
| | 8 | (6, 2) | 1 | (6, 2) | 1 | | |
| | 9 | (8, 5) | 1 | (8, 5) | 1 | | |
| | 10 | (3, 5) | 0 | | | | |
| | 11 | (2, 5) | 0 | | | | |
| | 12 | (5, 2) | 1 | | | | |
| | 13 | (4, 2) | 1 | | | | |
| | 14 | (3, 2) | 1 | | | | |
| | 15 | (2, 2) | 1 | | | | |
| | 16 | (1, 2) | 1 | | | | |
| | 17 | (0, 2) | 1 | | | | |
| | 18 | (3, 5) | 1 | | | | |
| | 19 | (2, 5) | 1 | | | | |
| TDD | 20 | (11, 1) | 1 | (11, 1) | 1 | (11, 1) | 1 |
| frame | 21 | (9, 1) | 1 | (9, 1) | 1 | (9, 1) | 1 |
| | 22 | (7, 1) | 1 | (7, 1) | 1 | (7, 1) | 1 |
| | 23 | (10, 1) | 1 | (10, 1) | 1 | | |
| | 24 | (8, 1) | 1 | (8, 1) | 1 | | |
| | 25 | (6, 1) | 1 | (6, 1) | 1 | | |
| | 26 | (5, 1) | 1 | | | | |
| | 27 | (4, 1) | 1 | | | | |
| | 28 | (3, 1) | 1 | | | | |
| | 29 | (2, 1) | 1 | | | | |
| | 30 | (1, 1) | 1 | | | | |
| | 31 | (0, 1) | 1 | | | | |

The following table illustrates a configuration of the CSI-RS in an extended CP.

TABLE 5

| | CSI-RS | Number of CSI-RS configuration | | | | | |
|---|---|---|---|---|---|---|---|
| | configuration | 1 or 2 | | 4 | | 8 | |
| | index | (k′, l′) | nₛ mod 2 | (k′, l′) | nₛ mod 2 | (k′, l′) | nₛ mod 2 |
| TDD and | 0 | (11, 4) | 0 | (11, 4) | 0 | (11, 4) | 0 |
| FDD | 1 | (9, 4) | 0 | (9, 4) | 0 | (9, 4) | 0 |
| frame | 2 | (10, 4) | 1 | (10, 4) | 1 | (10, 4) | 1 |
| | 3 | (9, 4) | 1 | (9, 4) | 1 | (9, 4) | 1 |
| | 4 | (5, 4) | 0 | (5, 4) | 0 | | |
| | 5 | (3, 4) | 0 | (3, 4) | 0 | | |
| | 6 | (4, 4) | 1 | (4, 4) | 1 | | |
| | 7 | (3, 4) | 1 | (3, 4) | 1 | | |
| | 8 | (8, 4) | 0 | | | | |
| | 9 | (6, 4) | 0 | | | | |
| | 10 | (2, 4) | 0 | | | | |
| | 11 | (0, 4) | 0 | | | | |
| | 12 | (7, 4) | 1 | | | | |
| | 13 | (6, 4) | 1 | | | | |
| | 14 | (1, 4) | 1 | | | | |
| | 15 | (0, 4) | 1 | | | | |
| TDD | 16 | (11, 1) | 1 | (11, 1) | 1 | (11, 1) | 1 |
| frame | 17 | (10, 1) | 1 | (10, 1) | 1 | (10, 1) | 1 |
| | 18 | (9, 1) | 1 | (9, 1) | 1 | (9, 1) | 1 |
| | 19 | (5, 1) | 1 | (5, 1) | 1 | | |
| | 20 | (4, 1) | 1 | (4, 1) | 1 | | |
| | 21 | (3, 1) | 1 | (3, 1) | 1 | | |
| | 22 | (8, 1) | 1 | | | | |
| | 23 | (7, 1) | 1 | | | | |
| | 24 | (6, 1) | 1 | | | | |
| | 25 | (2, 1) | 1 | | | | |
| | 26 | (1, 1) | 1 | | | | |
| | 27 | (0, 1) | 1 | | | | |

In the above two tables, UE may send a CSI-RS only in a downlink slot that satisfies the condition of ns mod 2. Furthermore, UE does not send a CSI-RS in a subframe in which the transmission of a special subframe, CSI-RS of a TDD frame collides against a synchronization signal, a PBCH (physical broadcast channel), and a system information block type 1 (SystemInformationBlockType1) or a subframe in which a paging message is transmitted. Furthermore, in a subset S, that is, S={15}, S={15, 16}, S={17, 18}, S={19, 20} or S={21, 22}, a resource element in which the CSI-RS of a single antenna port is transmitted is not used for the transmission of the CSI-RS of a PDSCH or another antenna port.

Meanwhile, FIG. 11 illustrates resource elements used for CSI-RS when a CSI-RS configuration index is 0 in a normal CP structure. Rp illustrates a resource element used for CSI-RS transmission on an antenna port p. Referring to FIG. 11, a CSI-RS for antenna ports 15 and 16 is transmitted through resource elements corresponding to the third subcarrier (i.e., subcarrier index 2) of the sixth and the seventh OFDM symbols (i.e., OFDM symbol indices 5, 6) of a first slot. A CSI-RS for antenna ports 17 and 18 is transmitted through resource elements corresponding to the ninth subcarrier (i.e., subcarrier index 8) of the sixth and the seventh OFDM symbols (OFDM symbols indices 5, 6) of the first slot. A CSI-RS for antenna ports 19 and 20 is transmitted through the same resource elements as those in which the CSI-RS for the antenna ports 15 and 16 is transmitted. The CSI-RS for the antenna ports 21 and 22 is transmitted through the same resource elements as those in which the CSI-RS for the antenna ports 17 and 18 are transmitted.

If the CSI-RS through eight antenna ports is transmitted to UE, the UE may receive an RB to which R15 to R22 has been mapped. That is, the UE may receive a CSI-RS having a specific pattern.

Meanwhile, a small cell is described below.

<Introduction of Small Cell>

In the next-generation mobile communication system, it is expected that a small cell having a small coverage radius will be added to the coverage of an existing cell and a small cell may process more traffic. The existing cell is called a macro cell because it has greater coverage than the small cell. This is described below with reference to FIG. 7.

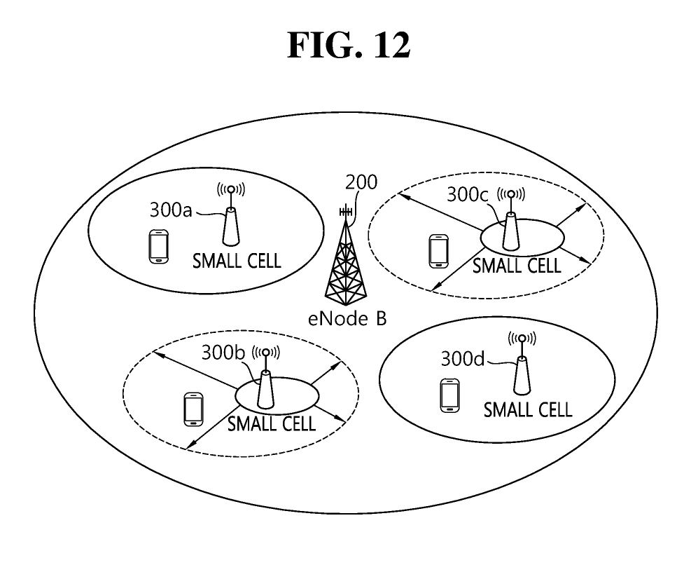

FIG. 12 is a Diagram Illustrating a Heterogeneous Network Environment in which a Macro Cell and Small Cells Having a Possibility that they May Become the Next-Generation Wireless Communication System are Mixed.

Referring to FIG. 12, a macro cell according to an existing eNodeB 200 has a heterogeneous network environment in which overlaps with small cells according to one or more small eNodeBs 300a, 300b, 300c, and 300d. The existing eNodeB is also called a macro eNodeB (MeNB) because it provides coverage greater than the small eNodeB. In this specification, a macro cell and a macro eNodeB are interchangeably used. UE connected to the macro cell 200 may be called macro UE. The macro UE receives a downlink signal from a macro eNodeB and sends an uplink signal to a macro eNodeB.

In such a heterogeneous network, the coverage gap of a macro cell may be filled by configuring the macro cell as a primary cell (Pcell) and configuring the small cell as a secondary cell Scell. Furthermore, overall performance can be boosted by configuring a small cell as a primary cell (Pcell) and configuring a macro cell as a secondary cell Scell.

Meanwhile, if the small cell is deployed as described above, an inter-cell interference problem may be worsened. In order to solve this problem, as illustrated in FIG. 12, the coverage size of the small cell may be reduced depending on its situation. Alternatively, the small cell may be off and then on depending on the situation.

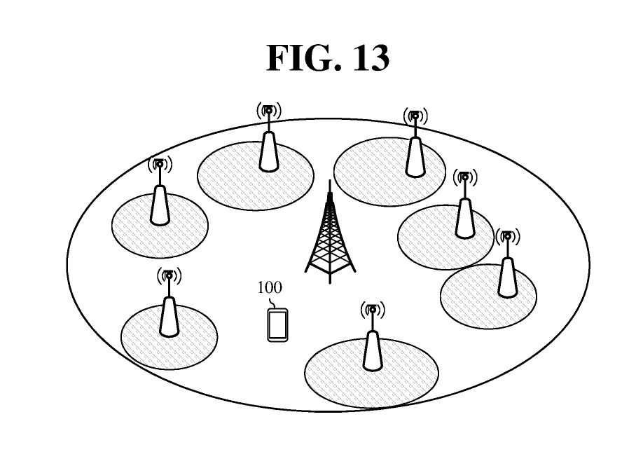

FIG. 13 is an exemplary diagram illustrating the situation in which small cells have been densely deployed.

Referring to FIG. 13, illustrated is the state in which small cells have been densely deployed within the coverage of a macro cell. In this state, it may be difficult for UE 100 to detect the small cells within a short time. In particular, as described above, cell detection is performed through the reception of a PSS/SSS. However, if many small cells send PSS/SSSs at the same timing, that is, on subframes Nos. 0 and 5, it may be difficult for the UE 100 to receive all the PSS/SSSs at once. Furthermore, if the small cells send the PSS/SSSs on the subframes Nos. 0 and 5 at the same time, mutual interference may be generated. As a result, it may be difficult for the UE 100 to correct receive the PSS/SSSs.

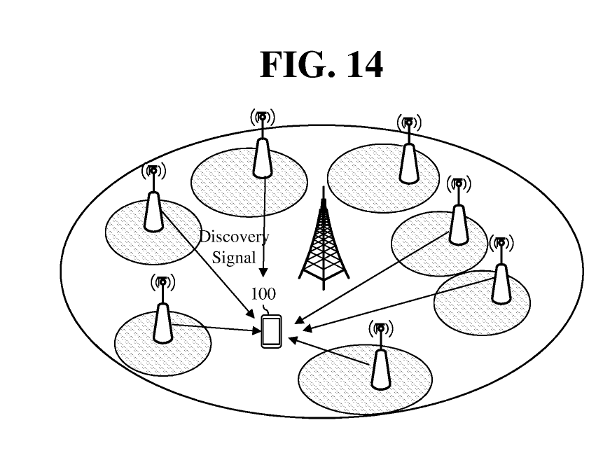

In order to solve the problem, the small cell may transmit a new discovery signal (DS) in addition to the existing PSS/SSS. Hereinafter, it will be explained by referring to FIG. 14.

FIG. 14 Illustrates an Example in which the Small Cell Transmits the Discovery Signal.

As may be seen with reference to FIG. 14, in order for UE to efficiently detect small cells, the small cell sends a new discovery signal (DS) in addition to an existing PSS/SSS. The discovery signal may be periodically transmitted even from the small cell of which a state is off.

The discovery signal may also be called a discovery reference signal (DRS). Accordingly, the UE needs to perform a cell search process or cell detection process using the discovery signal in addition to the existing PSS/SSS.

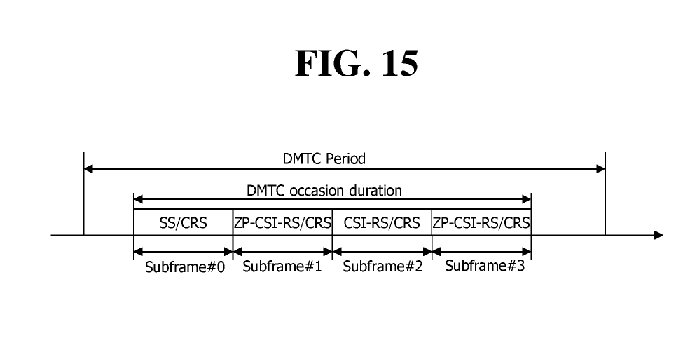

FIG. 15 Illustrates an Example of the Discovery Signal.

As may be seen with reference to FIG. 15, the discovery signal (DS) may be a combination of the followings.
CRS of antenna port 0 during a DwPTS of all downlink subframe and special subframe.
PSS on the first subframe of a period in a frame type 1 for the FDD or PSS on the second subframe of a period in a frame type 2 for the TDD
SSS on the first subframe in a period
None-zero power CSI-RS on zero or one or more subframe in the period

That is, the discovery signal (DS) may be a combination of the CRS, SS (i.e. PSS and SSS), and the CSI-RS.

Meanwhile, as shown in FIG. 15, an occasion duration of the discovery signal (DS) is as follows.
Continuous subframe of which a number is one through five, in the frame type 1 for the FDD.
Continuous subframe of which a number is two through five, in the frame type 2 for the TDD.

Meanwhile, the UE may receive, from an eNB, a discovery signal measurement timing configuration (DMTC) which is timing information for a discovery signal based measurement. The DMTC may be received in the MeasDS-Config field illustrated in the following table. The MeasDS-Config field may be received to be included in the Measurement objects illustrated in the Table 3. That is, the MeasDS-Config field in which the DMTC is defined, may be received to be included in the Measurement objects in a measurement configuration (MeasConfig) illustrated in the Table 3,

The UE does not consider that a transmission of the discovery signal has been sent on a subframe which is not defined in the DMTC.

TABLE 6
explanation of the MeasDS-Config field
csi-RS-IndividualOffset
CSI-RS individual offset applicable to a specific CSI-RS resource
dmtc-PeriodOffset
This means a dmtc-Periodicity and a dmtc-offset for a given frequency.
The DMTC Periodicity may be 40 ms, 80 ms, and . . . The DMTC offset
is represented as the number of the subframe. The occasion duration
of the DMTC is 6 ms.
ds-OccasionDuration
This means the occasion duration of the discovery signal for a given
frequency. The occasion duration of the discovery signal is common to
all cells which transmits the discovery signal on the given frequency.
physCellId
This means a physical cell ID. The UE assumes that the CSI-RS and the
PSS/SSS/CRS corresponding to the physical cell ID is quasi co-located
for a mean delay and a Doppler shift.
resourceConfig
This means the CSI-RS configuration.
subframeOffset
This means a subframe offset between the SSS and the CSI-RS of a cell
identified by the physical cell ID in the discovery signal occasion.

In the above table, the dmtc-Periodicity is a periodicity of measurement, and may indicate one of 40 ms, 80 ms, and 160 ms. In accordance with the periodicity, for example, the UE may perform a measurement once for every 160 ms based on the discovery signal (DS). The ds-OccasionDuration is the occasion duration of the discovery signal, and indicates the appropriate number of subframe of continuous subframe of one through five for the case of FDD, and indicates the appropriate number of subframe of continuous subframe of two through five for the case of TDD. For example, if the dmtc-Periodicity is 160 ms, and the occasion duration of the DMTC is 6 ms, the UE measures the discovery signal from the small cell for 6 ms.

Meanwhile, the above mentioned description of the small cell is summarized as follows.

The discovery signal and the measurement duration are newly defined for a cell identification and measurement of the small cell. The UE uses a discovery signal measurement timing configuration (DMTC) received from the serving cell for the cell identification and measurement of the small cell. The occasion duration of the DMTC is 6 ms and the DMTC periodicity indicates one of 40 ms, 80 ms, and 160 ms. That is, the UE performs detecting and measuring in the small cell within 6 ms of the DMTC occasion duration. According to the occasion duration of the discovery signal (DS), if the discovery signal (DS) is FDD, it may be received on one through five continuous subframes, and if it is FDD, it may be received on two through five continuous subframes. The SSS and the CRS is received on the first one of the subframes, and the PSS is further received for the case of FDD. The PSS is received on the second one of the subframes for the case of TDD.

The small cell may be on/off, and the UE detects a cell and performs a measurement by always using the discovery signal, regardless of an on/off state of the small cell, since it may not previously obtain information on whether the small cell is in the on state or off state.

The discovery signal has a purpose of a synchronization acquisition with the PSS/SSS, a CRS based RSRP measurement, a CSI-RS acquisition, and a CSI-RS based RSRP measurement.

The occasion duration of the discovery signal includes one through five continuous subframes for the case of FDD and includes two through five continuous subframes for the case of TDD.

As explained above, the SSS/CRS is received on the first subframe in the occasion duration of the discovery signal, the CSI-RS is received at a position distanced by the value of the subframeoffset from the SSS subframe.

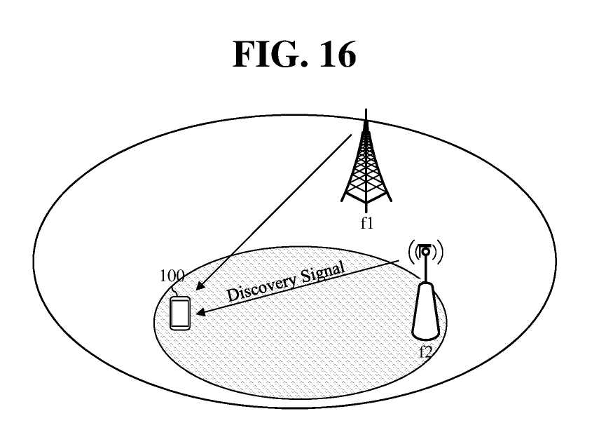

FIG. 16 Illustrates an Example in which the Macro Cell and the Small Cell are Operated on Different Frequencies.

Referring to FIG. 16, the macro cell which is the serving cell of the UE 100, is operated at a frequency f1, while the small cell is operated at a frequency f2.

When the small cell is operated in this manner at a frequency different from a frequency of the macro cell, let's assumed that the UE 100 identifies and measures in the small cell.

However, according to the current 3GPP standard, as previously explained by referring to the above table 3, the cell identification and RSRP measurement on different frequencies (inter frequency) is supposed to be performed within 6 ms length of the measurement gap (MG).

In this case, the UE assumes that the time to be used for the cell identification and measurement is 5 ms (i.e. five subframes). This is because 0.5 ms of front and rear portion of the measurement gap (MG) is assumed as the time to be used for actually retuning a RF. After 0.5 ms of the time for retuning the RF, the UE may perform the cell identification and measurement on different frequencies.

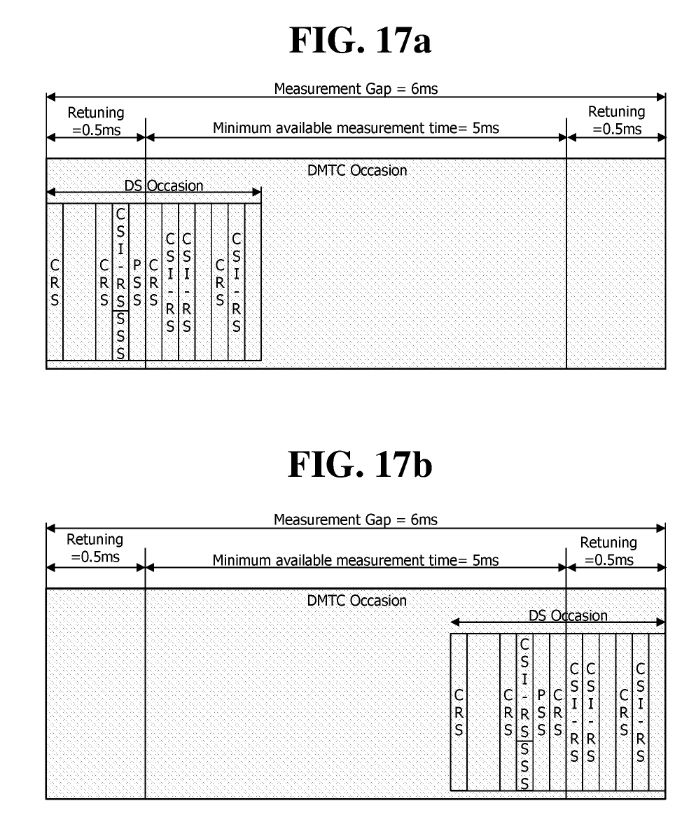

In this case, if the DMTC occasion duration and the measurement gap are identical to each other, the issue may be occurred. In this regard, it will be explained by referring to FIG. 17a to FIG. 17c.

FIG. 17a and FIG. 17b Illustrates an Example Occurred when a Measurement Gap (MG) and a DMTC Occasion Duration for Measuring on Different Frequencies is Identical to Each Other.

Firstly, referring to FIG. 17a, the measurement gap (MG) and the DMTC occasion duration is identical to each other and the starting point of the occasion duration of the discovery signal (DS) has been aligned to the starting point of the DMTC occasion duration. In this case, since the UE should retune the RF for 0.5 ms of the front portion of the measurement gap (MG), occurred is the issue that the CRS, CSI-RS, and SSS of the discovery signal has not received from the small cell during the 0.5 ms.

Next, referring to FIG. 17b, the measurement gap (MG) and the DMTC occasion duration is identical to each other and the end point of the occasion duration of the discovery signal (DS) has been aligned to the end point of the DMTC occasion duration. In this case, since the UE should retune the RF for 0.5 ms of the rear portion of the measurement gap (MG), occurred is the issue that the CRS, CSI-RS, and SSS of the discovery signal has not received from the small cell during the 0.5 ms.

<Disclosure of the Present Specification>

Thus, a disclosure of the present specification has purposes proposing a solution for solving the above mentioned problem.

In order to solve the above mentioned purpose, the present specification proposes configuring an offset between the measurement gap (MG) and the occasion duration the discovery signal (DS), if the small cell is operated on a frequency different from a frequency of the serving cell, when the small cell is detected and measured with the discovery signal.

The offset is defined in addition to the occasion duration of the discovery signal (DS). For example, the offset may be defined in the ds-OccasionDuration field illustrated in the MeasDS-Config field of the above table 6. Or, the offset may be configured by defining a new field separately from the ds-OccasionDuration field illustrated in the MeasDS-Config field of the above table 6.

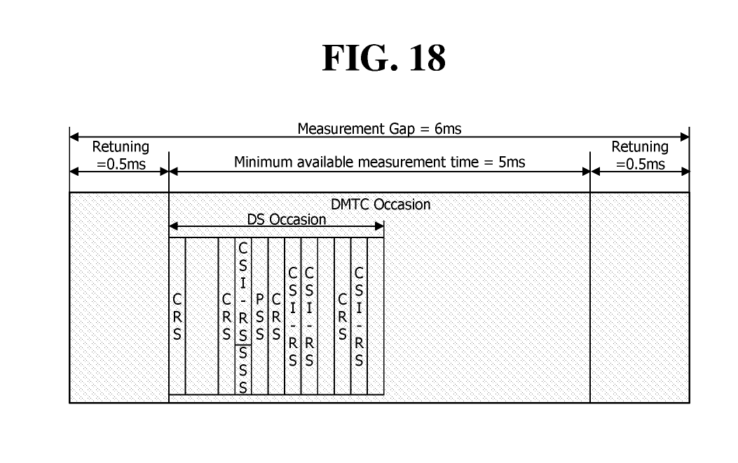

FIG. 18 Illustrates an Example in which a Subframe in which the Discovery Signal (DS) is Started to be Occurred is Offset from the Measurement Gap (MG) in Accordance with an Example of the Present Specification.

As may be seen with reference to FIG. 18, the measurement gap (MG) and the DMTC occasion duration is identical to each other, but the staring point of the discovery signal (DS) occasion duration is offset from the measurement gap (MG). Accordingly, the UE may all receive the discovery signal within of occasion duration of the discovery signal (DS).

In this case, the offset is differently configured based on the number of subframes of the occasion duration of the discovery signal (DS).

Hereinafter, a method of configuring the offset will be explained with the perspectives of the PSS/SSS, the CRS, and the CSI-RS, respectively.

I. Perspectives of the PSS/SSS

If a frequency of the small cell is different from that of the serving cell, the measurement gap (MG) as explained above is required. Specifically, if a RF structure of the UE uses a single RF chain, the measurement gap (MG) is required.

As explained above, if the occasion of the discovery signal (DS) is identical to the starting point of the measurement gap (MG) in FDD, the PSS/SSS is supposed to be positioned in the 0.5 ms of the RF retuning duration. This actually generates a distortion to the PSS/SSS signal, and as a result, performance is supposed to be degraded in terms of timing synchronization and physical cell ID (PCID) detection.

Thus, in a synchronized network (that is, a situation that the timing synchronization is matched among eNBs), in order to avoid these degradation in performance, the starting subframe of the occasion of the discovery signal (DS) should be configured to be always offset by at least one slot or at least one subframe from the starting subframe of the measurement gap (MG).

The offset value between the measurement gap (MG) start subframe and the occasion start subframe of the discovery signal (DS) is proposed based on the number of subframe N (one through five) of the occasion duration of the discovery signal (DS) as follows.

I-1. FDD, Synchronized Network

1) When the number of subframe of the occasion duration of the discovery signal (DS), N=1: The offset between the starting subframe of the measurement gap (MG) and a subframe of the occasion duration of the discovery signal (DS)=1, 2, 3, 4, 5

2) When the number of subframe of the occasion duration of the discovery signal (DS), N=2: The offset between the starting subframe of the measurement gap (MG) and a subframe of the occasion duration of the discovery signal (DS)=1, 2, 3, 4

3) When the number of subframe of the occasion duration of the discovery signal (DS), N=3: The offset between the starting subframe of the measurement gap (MG) and a subframe of the occasion duration of the discovery signal (DS)=1, 2, 3

4) When the number of subframe of the occasion duration of the discovery signal (DS), N=4: The offset between the starting subframe of the measurement gap (MG) and a subframe of the occasion duration of the discovery signal (DS)=1, 2

5) When the number of subframe of the occasion duration of the discovery signal (DS), N=5: The offset between the starting subframe of the measurement gap (MG) and a subframe of the occasion duration of the discovery signal (DS)=1

The above mentioned is summarized by illustrating as the table as follows.

TABLE 7

| N | 1 | 2 | 3 | 4 | 5 |
|---|---|---|---|---|---|
| Offset (Number of | 1, 2, 3, 4, 5 | 1, 2, 3, 4 | 1, 2, 3 | 1, 2 | 1 |
| subframe) | | | | | |

I-2. FDD, Asynchronized Network

Meanwhile, in an asynchronized network (that is, a situation that the timing synchronization is not matched among eNBs), the starting subframe of the occasion of the discovery signal (DS) should be configured to be always offset by at least two symbols from the starting subframe of the measurement gap (MG). The maximum offset is determined as follows based on the number of subframe of the occasion duration of the discovery signal (DS).

1) When N=1: The offset between the starting subframe of the measurement gap (MG) and a subframe of the occasion duration of the discovery signal (DS)=two symbols≦x≦five subframes

2) When N=2: The offset between the starting subframe of the measurement gap (MG) and a subframe of the occasion duration of the discovery signal (DS)=two symbols≦x≦four subframes

3) When N=3: The offset between the starting subframe of the measurement gap (MG) and a subframe of the occasion duration of the discovery signal (DS)=two symbols≦x≦three subframes

4) When N=4: The offset between the starting subframe of the measurement gap (MG) and a subframe of the occasion duration of the discovery signal (DS)=two symbols≦x≦two subframes

5) When N=5: The offset between the starting subframe of the measurement gap (MG) and a subframe of the occasion duration of the discovery signal (DS)=two symbols≦x≦one subframe

Meanwhile, for the case of TDD, since the PSS/SSS is not overlapped with 0.5 ms of the RF retuning duration, it is not required to consider the offset between the starting subframe of the measurement gap (MG) and a subframe of the occasion duration of the discovery signal (DS), such as the case of FDD.

II. Perspective of CRS

Firstly, four symbols of its number 0, 4, 7, and 11 are used for the CRS based RSRP measurement. Meanwhile, when N=1, if the starting point of the occasion duration of the discovery signal (DS) is identical to the measurement gap (MG) start position, and a transmission antenna port is assumed to be 1, then the symbol number 0 and 4 of the CRS is positioned in 0.5 ms of the RF retuning duration, and thus degradation is occurred in a RSRP performance and in a RSRQ performance.

Further, when N=1, if the end point of the occasion duration of the discovery signal (DS) is identical to the end point of the measurement gap (MG), and a transmission antenna port is assumed to be 1, then the symbol number 7 and 11 of the CRS is positioned in 0.5 ms of the RF retuning duration, and thus degradation is occurred in a RSRP performance and in a RSRQ performance.

Considering the above mentioned cases, it might be an issue to apply the existing CRS based RSRP performance standard in the same manner, and in order to avoid the issue, when N=1, it is required to configure the offset between the starting subframe of the occasion of the discovery signal (DS) and the measurement gap (MG) start subframe.

Accordingly, the offset in the proposed specification is proposed as follows.

1) When synchronous network, N=1:

The offset between the starting subframe of the measurement gap (MG) and a subframe of the occasion duration of the discovery signal (DS)=1, 2, 3, 4

2) When asynchronous network, N=1:

The offset between the starting subframe of the measurement gap (MG) and a subframe of the occasion duration of the discovery signal (DS)=one slot≦x≦four subframes+one slot

III. Perspective of PSS/SSS and CRS

Meanwhile, considering both the above mentioned perspective of PSS/SSS and both the above mentioned perspective of CRS, the offset is the same as follows.

III-1. FDD, Synchronous network

1) When N=1: The offset between the starting subframe of the measurement gap (MG) and a subframe of the occasion duration of the discovery signal (DS)=1, 2, 3, 4

2) When N=2: The offset between the starting subframe of the measurement gap (MG) and a subframe of the occasion duration of the discovery signal (DS)=1, 2, 3, 4

3) When N=3: The offset between the starting subframe of the measurement gap (MG) and a subframe of the occasion duration of the discovery signal (DS)=1, 2, 3

4) When N=4: The offset between the starting subframe of the measurement gap (MG) and a subframe of the occasion duration of the discovery signal (DS)=1, 2

5) When N=5: The offset between the starting subframe of the measurement gap (MG) and a subframe of the occasion duration of the discovery signal (DS)=1

III-2. FDD, Asynchronous Network

1) When N=1: The offset between the starting subframe of the measurement gap (MG) and a subframe of the occasion duration of the discovery signal (DS)=one slot≦x≦four subframes+one slot

2) When N=2: The offset between the starting subframe of the measurement gap (MG) and a subframe of the occasion duration of the discovery signal (DS)=two symbols≦x≦four subframes

3) When N=3: The offset between the starting subframe of the measurement gap (MG) and a subframe of the occasion duration of the discovery signal (DS)=two symbols≦x≦three subframes

4) When N=1: The offset between the starting subframe of the measurement gap (MG) and a subframe of the occasion duration of the discovery signal (DS)=two symbols≦x≦two subframes

5) When N=1: The offset between the starting subframe of the measurement gap (MG) and a subframe of the occasion duration of the discovery signal (DS)=two symbols≦x≦one subframe

The above proposed all offset values, may be changed based on the actual network environment.

IV. Perspective of CSI-RS

If the CSI-RS is positioned within 0.5 ms of the RF retuning duration in the starting portion and end portion of the measurement gap (MG), performance is supposed to be degraded in terms of the CSI-RS identification and the CSI-RS based RSRP measurement.

Accordingly, the offset should be configured in the above mentioned manner.

However, if the offset is not configured or is configured to be 0, it is proposed to have set the CSI-RS configuration in which 0.5 ms of the starting and end portion of the measurement gap (MG) is not overlapped with the CSI-RS in the present specification, in order to avoid the above mentioned degradation in performance

Specifically, if the synchronized network is assumed, it is proposed to exclude the CSI reference signal configuration number 0, 5, 10, 11 (0th slot) for the case of normal CP, while it is proposed to exclude the CSI reference signal configuration number 0, 1, 4, 5, 8, 9, 10, 11 for the case of extended CP, when the measurement gap (MG) start subframe is overlapped with the starting subframe of the occasion of the discovery signal (DS), and the CSI-RS is configured in the starting subframe of the occasion of the discovery signal (DS).

Furthermore, in the synchronous network, it is proposed to use a CSI reference signal configuration number 0, 5, 10, 11 for the case of normal CP, while it is proposed to use the CSI reference signal configuration number 0, 1, 4, 5, 8, 9, 10, 11 for the case of extended CP, when the measurement gap (MG) end subframe is overlapped with the end subframe of the occasion of the discovery signal (DS), and the CSI-RS is configured in the end subframe of the occasion of the discovery signal (DS).

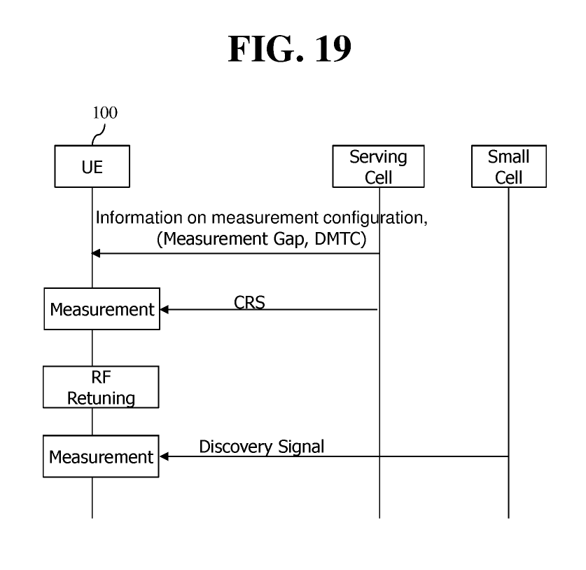

FIG. 19 is a flow diagram illustrating and arranging the disclosure of the present specification.

As may be seen with reference to FIG. 19, a UE 100 receives measurement configuration information from a serving cell. The measurement configuration information may be the measconfig illustrated in the table 3. Specifically, the measurement configuration information, i.e. the measconfig may include a measurement gap (MG), i.e. the measGapConfig indicating time duration for measuring a neighboring small cell operated in a frequency different from a frequency of the serving cell. Further, the measurement configuration information, i.e. a Measurement object in the measconfig may include a discovery signal measurement timing configuration (DMTC), i.e. the MeasDS-Config, for the neighboring small cell.

In this case, the DMTC, i.e. the MeasDS-Config, may include information on the occasion duration of the discovery signal (DS). Further, according to the disclosure of the present invention, the DMTC, i.e. the MeasDS-Config, may further include offset information between the starting subframe of the measurement gap (MG) and a subframe of the occasion duration of the discovery signal (DS).

Meanwhile, the UE 100 performs a measurement by using the CSI received from the serving cell.

Then, if the measurement gap (MG) is started, the UE 100 retunes a RF to measure the small cell operated on a frequency different from a frequency of the serving cell.

Furthermore, the UE 100 performs a measurement based on the discovery signal received from the small cell during the occasion duration of the discovery signal from a point distanced by the offset from the measurement gap (MG).

Meanwhile, as explained above, the offset may be changed based on the number of subframe N indicating the occasion duration of the discovery signal. As explained above, N may be a value of one through five.

Since other items are apparent from those skilled in the art from the above mentioned items, it would not be explained again by referring to FIG. 19.

The above mentioned embodiments of the present invention may be implemented by various means. For example, embodiments of the present invention may be implemented by hardware, firmware, software, or combinations thereof. Specifically, embodiments of the present invention will be explained by referring to the following diagram.

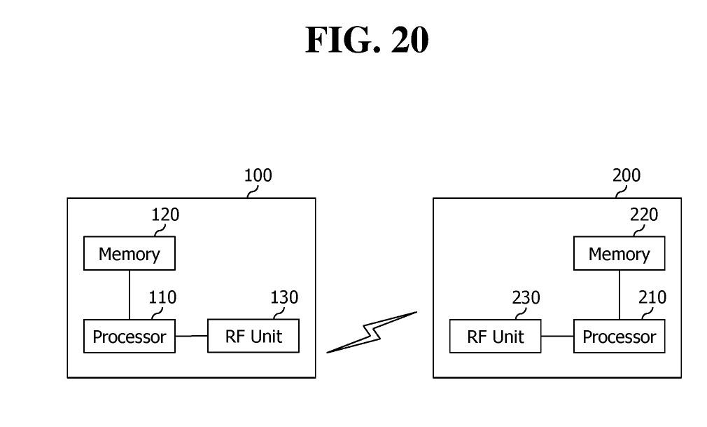

FIG. 20 is a block diagram illustrating a wireless communications system in which the disclosure of the present specification is implemented.

A BS 200 includes a processor 201, a memory 202 and an RF (radio frequency) unit 203. The memory 202 is connected to the processor 201, and stores various information for driving the processor 201. The RF unit 203 is connected to the processor 201, and transmits and/or receives radio signals. The processor 201 implements proposed functions, processes and/or methods. In the above mentioned embodiment, the operation of the BS 50 can be implemented by the processor 201.

A UE 100 includes a processor 101, a memory 102 and an RF unit 103. The memory 102 is connected to the processor 61, and stores various information for driving the processor 101. The RF unit 103 is connected to the processor 101, and transmits and/or receives radio signals. The processor 101 implements proposed functions, processes and/or methods.

The processor may include Application-Specific Integrated Circuits (ASICs), other chipsets, logic circuits, and/or data processors. The memory may include Read-Only Memory (ROM), Random Access Memory (RAM), flash memory, memory cards, storage media and/or other storage devices. The RF unit may include a baseband circuit for processing a radio signal. When the above-described embodiment is implemented in software, the above-described scheme may be implemented using a module (process or function) which performs the above function. The module may be stored in the memory and executed by the processor. The memory may be disposed to the processor internally or externally and connected to the processor using a variety of well-known means.

In the above exemplary systems, although the methods have been described on the basis of the flowcharts using a series of the steps or blocks, the present invention is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present invention.

What is claimed is:

1. A method for measuring a discovery signal of a small cell, the method comprising:
receiving a discovery signal measurement timing configuration (DMTC) for a neighboring small cell,
wherein the DMTC includes information on a DMTC periodicity and information on an occasion duration of the discovery signal,
wherein the occasion duration of the discovery signal indicates at least one subframe on which the discovery signal occurs; and
if the neighboring small cell operates in a frequency different from a frequency of a serving cell, performing a measurement on the neighboring small cell during a measurement gap,
wherein the at least one subframe on which the discovery signal occurs and indicated by the information on the occasion duration is distanced by a predetermined offset from the measurement gap,
wherein the predetermined offset includes at least one slot or more than one slot.

2. The method of claim 1, wherein the information on a DMTC periodicity indicates one of 40 ms, 80 ms, and 160 ms.

3. The method of claim 1, wherein the at least one subframe on which the discovery signal occurs and indicated by the information on the occasion duration includes a number of one through five subframes.

4. The method of claim 1, wherein the DMTC and the measurement gap are received as being included in measurement configuration information.

5. The method of claim 1, wherein the discovery signal includes one or more of a primary synchronization signal (PSS), a secondary synchronization signal (SSS), a cell-specific reference Signal (CRS) and a channel state information reference signal (CSI-RS).

6. The method of claim 5, wherein if the serving cell and the neighboring small cell are synchronized in time, the offset for the CRS, the PSS and the SSS of the discovery signal is a length of at least one subframe.

7. The method of claim 5, wherein if a value of the offset is 0, a CSI-RS configuration is used of which a time duration required retuning a RF to the different frequency for measuring the neighboring small cell, is not overlapped.

8. A user equipment for measuring a discovery signal of a small cell, the user equipment comprising:
a radio frequency (RF) unit configured to receive a discovery signal measurement timing configuration (DMTC) for a neighboring small cell,
wherein the DMTC includes information on a DMTC periodicity and information on an occasion duration of the discovery signal, and
wherein the occasion duration of the discovery signal indicates at least one subframe on which the discovery signal occurs; and
a processor configured to perform a measurement on the neighboring small cell during a measurement gap, if the neighboring small cell operates in a frequency different from a frequency of a serving cell,
wherein the at least one subframe on which the discovery signal occurs and indicated by the information on the occasion duration is distanced by a predetermined offset from the measurement gap, and
wherein the predetermined offset includes at least one slot or more than one slot.

9. The user equipment of claim 8, wherein the information on a DMTC periodicity indicates one of 40 ms, 80 ms, and 160 ms.

10. The user equipment of claim 8, wherein the at least one subframe on which the discovery signal occurs and indicated by the information on the occasion duration includes a number of one through five subframes.

11. The user equipment of claim 8, wherein the DMTC and the measurement gap are received as being included in measurement configuration information.

12. The user equipment of claim 8, wherein the discovery signal includes one or more of a primary synchronization signal (PSS), a secondary synchronization signal (SSS), a cell-specific reference Signal (CRS) and a channel state information reference signal (CSI-RS).

13. The user equipment of claim 5, wherein if the serving cell and the neighboring small cell are synchronized in time, the offset for the CRS, the PSS and the SSS of the discovery signal is a length of at least one subframe.

14. The user equipment of claim 5, wherein if a value of the offset is 0, a CSI-RS configuration is used of which a time duration required retuning a RF to the different frequency for measuring the neighboring small cell, is not overlapped.
